(19) United States
(12) Patent Application Publication
(10) Pub. No.: US 2026/0017298 A1
(43) Pub. Date: Jan. 15, 2026

(54) PROMPT AUGMENTATION BASED ON ENTITY TAGGING

(71) Applicant: ADOBE INC., SAN JOSE, CA (US)

(72) Inventors: Oliver Brdiczka, San Jose, CA (US); Anand Khanna, San Jose, CA (US); Yibo He, Franklin, NJ (US); Sapna Meghan Nayan, Seattle, WA (US); Christopher James Gammon, Waunakee, WI (US)

(21) Appl. No.: 18/773,274

(22) Filed: Jul. 15, 2024

(51) Int. Cl. G06F 16/33; G06F 16/332; G06F 40/279; G06T 11/00

(52) U.S. Cl. CPC G06F 16/3338; G06F 16/3322; G06F 40/279; G06T 11/00

(57) ABSTRACT

A method, apparatus, non-transitory computer readable medium, and system for media processing include receiving a text prompt including an entity phrase, marking the entity phrase within the text prompt to obtain a revised prompt, generating a replacement phrase by performing autoregressive token generation based on a sequence of tokens from the revised prompt, where the replacement phrase comprises a variant of the entity phrase, and generating an augmented prompt that includes the replacement phrase.

### BACKGROUND

Media items such as text, images, video, and audio may be generated or retrieved based on a text prompt. The quality of the media item tends to be positively correlated with an amount of detail and specificity included in the text prompt. For example, adding detailing adjectives to subjects included in a text prompt tends to increase both an image quality of a generated image and a text-to-image alignment of the text prompt and the generated image. However, effective prompt writing is a learned skill, and an inability to provide sufficiently detailed prompts may deter unskilled users from prompt-based media retrieval or generation.

### SUMMARY

Systems and methods are described for replacing a semantic entity in a text prompt using a language generation model. In one example, a phrase describing the semantic entity is marked in the text prompt to obtain a revised prompt, and a language generation model generates a replacement phrase for the marked phrase based on the revised prompt. The phrase is replaced with the replacement phrase to obtain an augmented prompt.

The marked phrase allows the language generation model to generate the replacement phrase based on the context of the revised prompt as a whole, thereby allowing the replacement phrase to better fit with the intent of the text prompt. The augmented prompt can be used to obtain a media item, such as text, image, video, or audio. Accordingly, users can create expressive prompts that positively impact a quality of the media item.

This Summary introduces a selection of concepts in a simplified form that are further described below in the Detailed Description. As such, this Summary is not intended to identify essential features of the claimed subject matter, nor is it intended to be used as an aid in determining the scope of the claimed subject matter.

### BRIEF DESCRIPTION OF THE DRAWINGS

The detailed description is described with reference to the accompanying figures. Entities represented in the figures are indicative of one or more entities and thus reference is made interchangeably to single or plural forms of the entities in the discussion.

FIG. 1 shows an example of a media processing system that employs a prompt augmentation method according to aspects of the present disclosure.

FIG. 2 shows an example of a method for obtaining a media item using a prompt augmentation method according to aspects of the present disclosure.

FIG. 3 shows an example of a media processing system for generating an augmented prompt using an entity marking method according to aspects of the present disclosure.

FIG. 4 shows an example of a media processing system for generating a synthetic image based on an augmented prompt according to aspects of the present disclosure.

FIG. 5 shows an example of a media processing system for retrieving a media item based on an augmented prompt according to aspects of the present disclosure.

FIG. 6 shows an example of a transformer according to aspects of the present disclosure.

FIG. 7 shows an example of a method for generating an augmented prompt according to aspects of the present disclosure.

FIG. 8 shows an example of a user interface for displaying an augmented prompt according to a prompt augmentation method according to aspects of the present disclosure.

FIG. 9 shows an example of a method for training a language generation model according to aspects of the present disclosure.

FIG. 10 shows an example of a media processing system for training a language generation model according to aspects of the present disclosure.

FIG. 11 shows an example of a flow diagram depicting an algorithm as a step-by-step procedure for training a machine learning model according to aspects of the present disclosure.

FIG. 12 shows an example of a computing device according to aspects of the present disclosure.

FIG. 13 shows an example of a media processing apparatus according to aspects of the present disclosure.

### DETAILED DESCRIPTION

### Overview

Media items such as text, images, video, and audio may be generated or retrieved based on a text prompt. The quality of the media item tends to be positively correlated with an amount of detail and specificity included in the text prompt. For example, adding detailing adjectives to subjects included in a text prompt tends to increase both an image quality of a generated image and a text-to-image alignment of the text prompt and the generated image. However, effective prompt writing is a learned skill, and an inability to provide sufficiently detailed prompts may deter unskilled users from prompt-based media retrieval or generation.

According to some aspects, a media processing system generates a replacement phrase for an entity phrase (e.g., a phrase referring to a semantic entity) included in a text prompt, and generates an augmented prompt by replacing the entity phrase with the replacement phrase. The replacement phrase may be more descriptive than the entity phrase, and therefore a better media item (such as an image) may be generated or retrieved based on the augmented prompt than on the text prompt.

A conventional large language model employs an autoregressive token generation technique. For example, when a large language model predicts a next token to be generated, the large language model attends to (i.e., uses as context) past tokens that have either been passed in as an instruction or have been previously generated by the large language model. Therefore, for a scenario in which a phrase is to be replaced in an input sentence, conventional large language models are only able to attend to words preceding the phrase, and not to words following the phrase, and therefore cannot generate a replacement for the phrase based on a context of the sentence as a whole.

According to some aspects, the language generation model generates the replacement phrase by performing autoregressive token generation based on a sequence of tokens from a revised prompt. In some examples, the language generation model is trained to understand that, for a given input sequence (e.g., the revised prompt), a marked entity phrase is meant to be replaced, and that a replacement phrase for the marked entity phrase should be generated by attending to every token of the input sequence up to an end-of-sequence tag (e.g., “<eos>”). For example, by using a first tag and a second tag surrounding an entity phrase as proxies for a marked entity phrase in an input sequence, the language generation model is able to look backwards (attend to previous tokens) but also consume a full context of the input sequence before generating the replacement phrase.

Accordingly, the language generation model is able to generate replacement phrases for an entity phrase that use an entire sentence as context, thereby allowing a meaning of the replacement phrase to better match a meaning of the sentence as compared to conventional large language models. Therefore, aspects of the present disclosure provide a media processing system that improves on conventional language generation technology by using a language generation model that is trained to generate a replacement phrase based on a revised prompt, which increases a contextual accuracy of the replacement phrase. By contrast, conventional large language models cannot generate replacement phrases for entity phrases using words that follow the entity phrases as context.

According to some aspects, the process of generating an augmented prompt can be iteratively repeated, allowing for effectively infinite prompt expansion and branching and an optimization towards a desired output, where the iterations of the augmented prompts reflect a “personality” via the replacement phrases that are generated using the context of the prompts as a whole.

An example of a media processing system according to the present disclosure is used in an image generation context. In the example, the user provides a text prompt “A parallel universe where gravity works differently” to the system. The system identifies “parallel universe” as an entity phrase and marks the entity phrase to obtain a revised prompt. A language generation model of the system generates “alternate dimension” as a replacement phrase for “parallel universe” based on the context of the revised prompt as a whole. The user approves the replacement phrase, and the system generates an augmented prompt “A alternate dimension where gravity works differently”. An image generation model of the system generates an image depicting an alternate dimension where gravity works differently, and the system displays the image to the user.

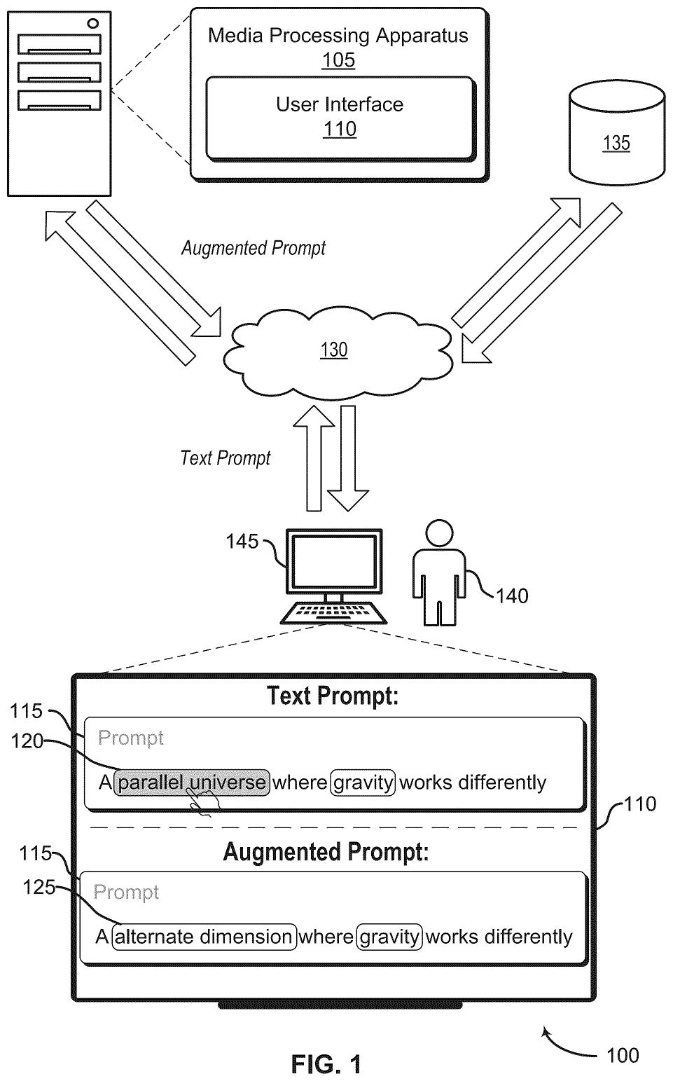

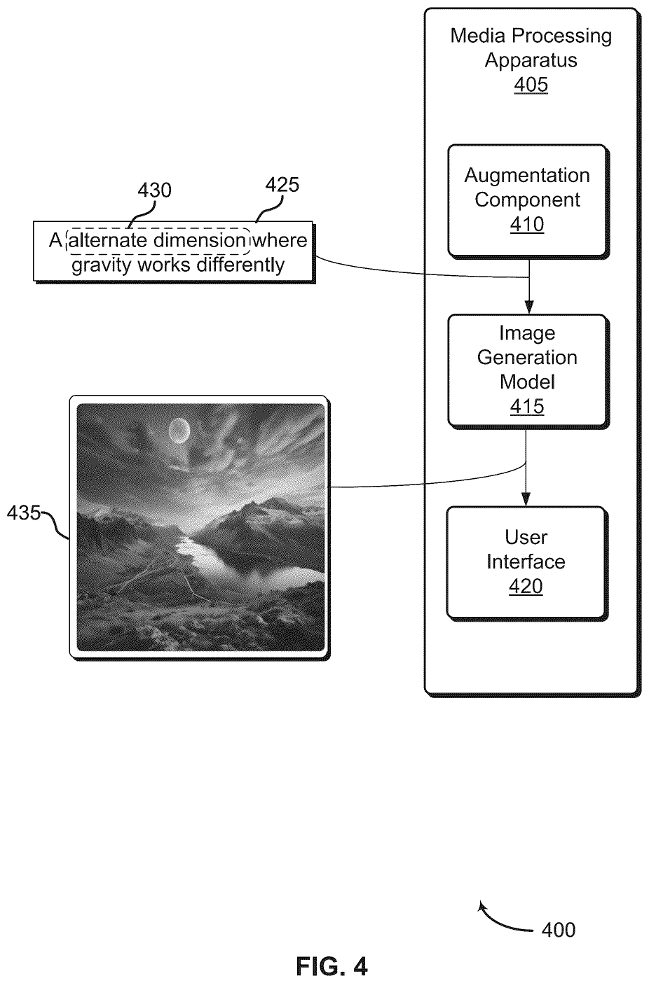

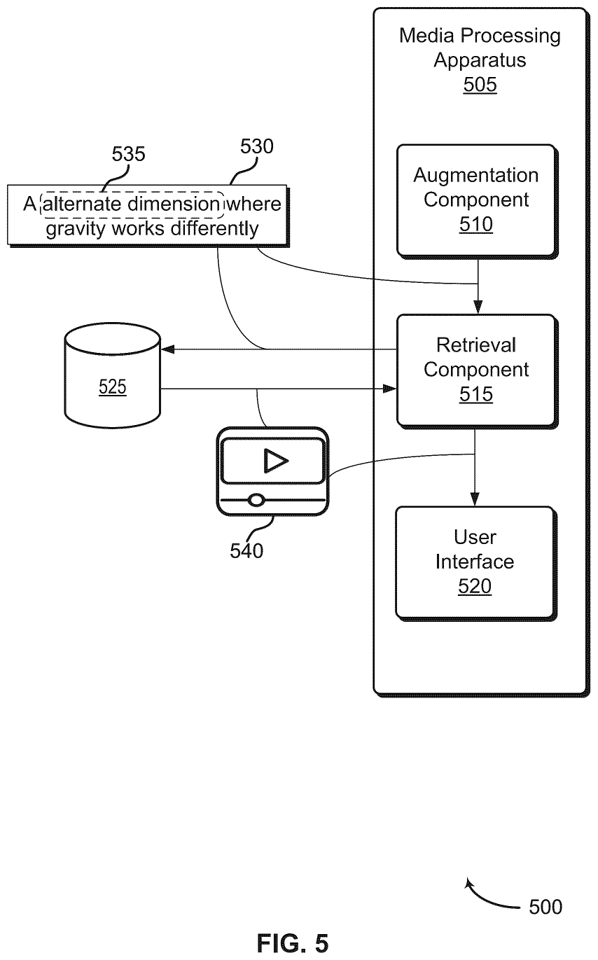

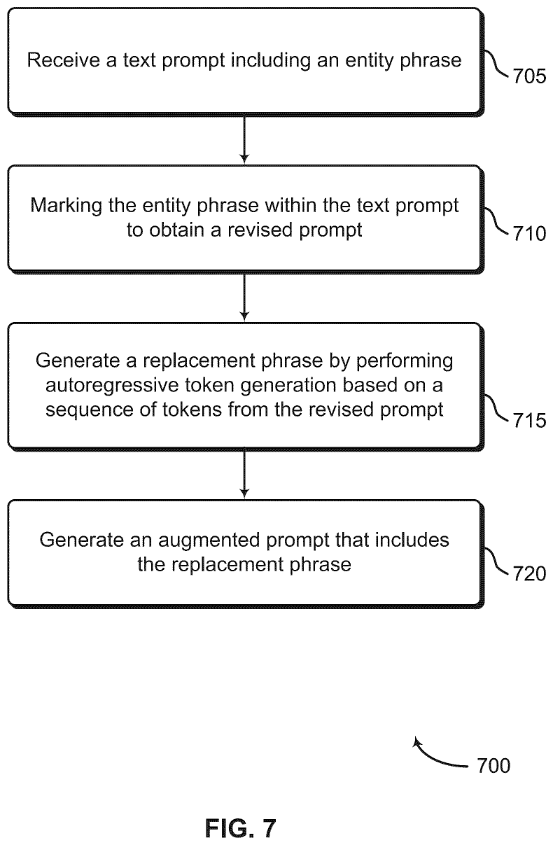

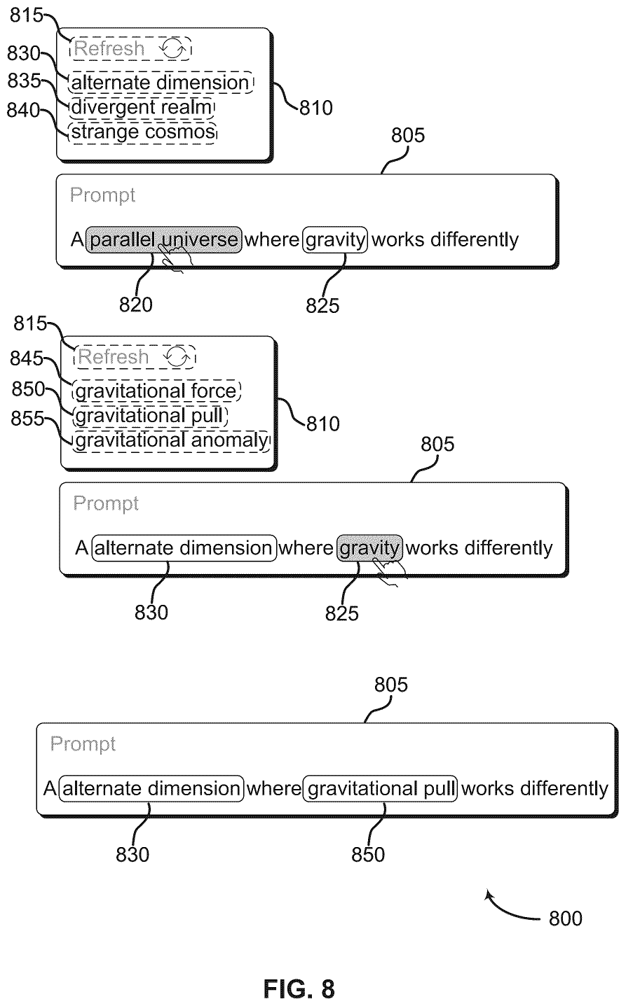

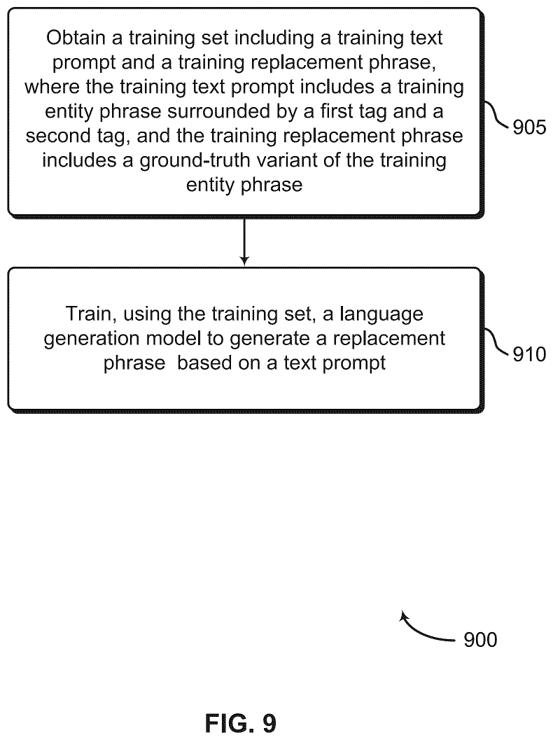

Further example applications of the present disclosure in a context of obtaining media based on an augmented prompt are provided with reference to FIGS. 4 and 5. Details regarding the architecture of the media processing system are provided with reference to FIGS. 1-6 and 12-13. Examples of a process for generating an augmented prompt are provided with reference to FIGS. 7-8. Examples of a process for training a machine learning model are provided with reference to FIGS. 9-11.

### Media Processing System

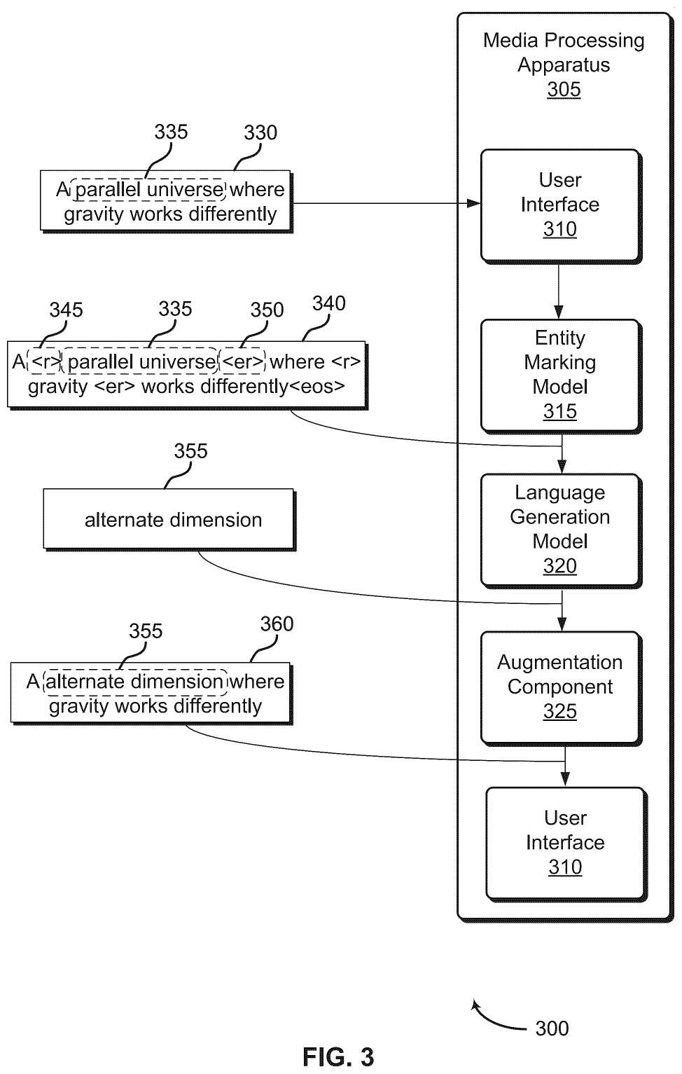

FIG. 1 shows an example of a media processing system 100 that employs a prompt augmentation method according to aspects of the present disclosure. The example shown includes media processing system 100, entity phrase 120, replacement phrase 125, user 140, and user device 145. Media processing system 100 is an example of, or includes aspects of, the corresponding element described with reference to FIGS. 3-5 and 10. In one aspect, media processing system 100 includes media processing apparatus 105, cloud 130, and database 135. Entity phrase 120 is an example of, or includes aspects of, the corresponding element described with reference to FIG. 3. Replacement phrase 125 is an example of, or includes aspects of, the corresponding element described with reference to FIGS. 3-5.

Media processing apparatus 105 is an example of, or includes aspects of, the corresponding element described with reference to FIGS. 3-5, 9, and 13. In one aspect, media processing apparatus 105 includes user interface 110. User interface 110 is an example of, or includes aspects of, the corresponding element described with reference to FIGS. 3-5, and 8. In one aspect, user interface 110 includes prompt element 115. Prompt element 115 is an example of, or includes aspects of, the corresponding element described with reference to FIG. 8.

In the example of FIG. 1, media processing apparatus 105 displays user interface 110 on user device 145. User interface 110 receives a text prompt “A parallel universe where gravity works differently” including entity phrase 120 (“parallel universe”) and an additional entity phrase (“gravity”) from user 140 via user device 145. An entity marking model (such as the entity marking model 315 described with reference to FIG. 3) identifies “parallel universe” and “gravity” as entity phrases and marks the entity phrases to obtain a revised prompt. User interface 110 displays the text prompt in prompt element 115 with the identified entity phrases highlighted.

User interface 110 receives an input from user 140 selecting entity phrase 120. In response to the input, a language generation model (such as the language generation model 320 described with reference to FIG. 3) generates a set of replacement phrases including replacement phrase 125 (“alternate dimension”) based on the revised prompt. User interface 110 receives a user input from user 140 selecting replacement phrase 125 from among the set of replacement phrases. In response to the selection, an augmentation component (such as the augmentation component 325 described with reference to FIG. 3) replaces entity phrase 120 with replacement phrase 125 to obtain an augmented prompt. Prompt element 115 displays the augmented prompt.

According to some aspects, user device 145 is a personal computer, laptop computer, mainframe computer, palmtop computer, personal assistant, mobile device, or any other suitable processing apparatus. User device 145 may include software that displays user interface 110. User interface 110 allows information (such as images, prompts, etc.) to be communicated between user 140 and media processing apparatus 105.

According to some aspects, a user device user interface enables user 140 to interact with user device 145. In some embodiments, the user device user interface may include an audio device, such as an external speaker system, an external display device such as a display screen, or an input device (e.g., a remote-control device interfaced with the user interface directly or through an I/O controller module). In some cases, the user device user interface may be a graphical user interface.

According to some aspects, media processing apparatus 105 includes a computer-implemented network. In some embodiments, the computer-implemented network includes a machine learning model (such as the entity marking model 315 and the language generation model 320 described with reference to FIG. 3).

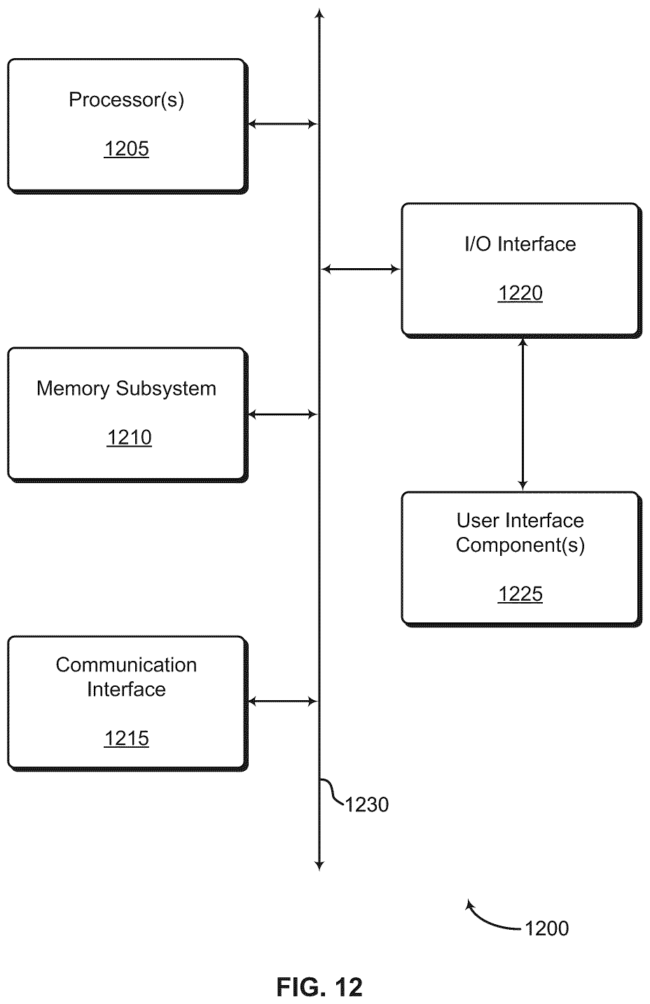

Media processing apparatus 105 may also include one or more processors, a memory subsystem, a communication interface, an I/O interface, one or more user interface components, and a bus as described with reference to FIG. 12. Additionally, media processing apparatus 105 may communicate with user device 145 and database 135 via cloud 130.

According to some aspects, media processing apparatus 105 is implemented on a server. A server provides one or more functions to users linked by way of one or more of various networks, such as cloud 130. The server may include a microprocessor board that includes a microprocessor responsible for controlling all aspects of the server. The server uses the microprocessor and protocols such as hypertext transfer protocol (HTTP), simple mail transfer protocol (SMTP), file transfer protocol (FTP), and simple network management protocol (SNMP) to exchange data with other devices or users on one or more of the networks. The server may be configured to send and receive hypertext markup language (HTML) formatted files (e.g., for displaying web pages). In various embodiments, the server comprises a general-purpose computing device, a personal computer, a laptop computer, a mainframe computer, a supercomputer, or any other suitable processing apparatus.

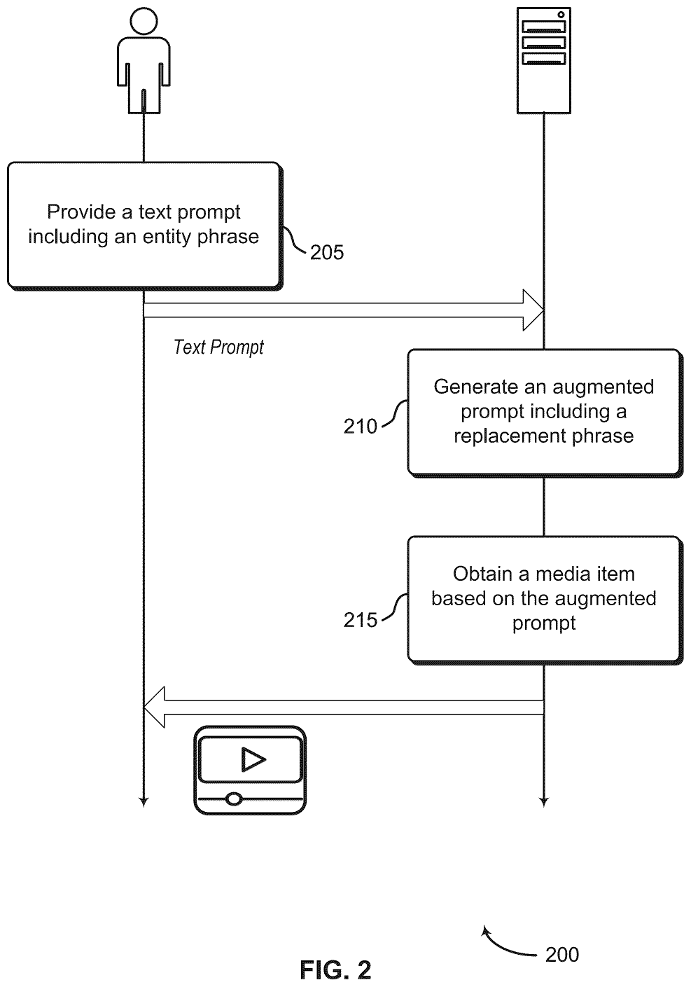

Further detail regarding the architecture of a media processing system is provided with reference to FIGS. 2-6 and 12-13. Further detail regarding a process for generating an augmented prompt is provided with reference to FIGS. 7-8. Further detail regarding a process for training a machine learning model is provided with reference to FIGS. 9-11.

Cloud 130 is a computer network configured to provide on-demand availability of computer system resources, such as data storage and computing power. Cloud 130 may provide resources without active management by a user. The term “cloud” is sometimes used to describe data centers available to many users over the Internet. Some large cloud networks have functions distributed over multiple locations from central servers. A server is designated an edge server if the server has a direct or close connection to a user. Cloud 130 may be limited to a single organization or be available to many organizations. In one example, cloud 130 includes a multi-layer communications network comprising multiple edge routers and core routers. In another example, cloud 130 is based on a local collection of switches in a single physical location. According to some aspects, cloud 130 provides communications between user device 145, media processing apparatus 105, and database 135.

Database 135 is an organized collection of data. In an example, database 135 stores data in a specified format known as a schema. According to some aspects, database 135 is structured as a single database, a distributed database, multiple distributed databases, or an emergency backup database. A database controller may manage data storage and processing in database 135. A user may interact with the database controller, or the database controller may operate automatically without interaction from the user. According to some aspects, database 135 is included in media processing apparatus 105. According to some aspects, database 135 is external to media processing apparatus 105 and communicates with media processing apparatus 105 via cloud 130. Database 135 is an example of, or includes aspects of, the corresponding element described with reference to FIG. 5.

FIG. 2 shows an example of a method 200 for obtaining a media item using a prompt augmentation method according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

Referring to FIG. 2, an example of a media processing system according to the present disclosure is used a context of obtaining a media item based on an augmented prompt. In the example, the user provides a text prompt including an entity phrase to the system. The system identifies and marks the entity phrase to obtain a revised prompt. A language generation model of the system generates a replacement phrase for the entity phrase based on the context of the revised prompt as a whole. The system generates an augmented prompt by replacing the entity phrase with the replacement phrase. The system then obtains a media item using the augmented prompt.

At operation 205, the user provides a text prompt including an entity phrase. In some cases, the operations of this step may be performed by a user as described with reference to FIG. 1. For example, the user provides the text prompt to a user interface of the system as described with reference to FIG. 3.

At operation 210, the system generates an augmented prompt including a replacement phrase. In some cases, the operations of this step refer to, or may be performed by, a media processing apparatus as described with reference to FIG. 1. For example, the media processing apparatus replaces the entity phrase with the replacement phrase to obtain the augmented prompt as described with reference to FIG. 3.

At operation 215, the system obtains a media item based on the augmented prompt. In some cases, the operations of this step refer to, or may be performed by, a media processing apparatus as described with reference to FIG. 1. In an example, the media processing system generates the media item based on the augmented prompt as described with reference to FIG. 4. In another example, the media processing system retrieves the media item based on the augmented prompt as described with reference to FIG. 5. According to some aspects, the system displays the media item to the user via the user interface.

FIG. 3 shows an example of a media processing system 300 for generating an augmented prompt using an entity marking method according to aspects of the present disclosure. The example shown includes media processing system 300, text prompt 330, revised prompt 340, replacement phrase 355, and augmented prompt 360.

Media processing system 300 is an example of, or includes aspects of, the corresponding element described with reference to FIGS. 1, 4, 5, and 10. In one aspect, media processing system 300 includes media processing apparatus 305. Media processing apparatus 305 is an example of, or includes aspects of, the corresponding element described with reference to FIGS. 1, 4, 5, 10, and 13. In one aspect, media processing apparatus 305 includes user interface 310, entity marking model 315, language generation model 320, and augmentation component 325.

According to some aspects, user interface 310 receives a text prompt (such as text prompt 330). In an example, a user enters the text prompt into a prompt element of user interface 310. User interface 310 may be displayed by media processing apparatus 305 on a user device (such as the user device 145 described with reference to FIG. 1). In the example of FIG. 3, the text prompt includes the text string “A parallel universe where gravity works differently”. User interface 310 is an example of, or includes aspects of, the corresponding element described with reference to FIGS. 1, 4, 5, and 8.

According to some aspects, entity marking model 315 identifies one or more entity phrases (such as entity phrase 335) in the text prompt using a natural language processing (NLP) model. An “entity phrase” is a group of one or more words that refer to a semantic entity, such as one or more nouns and optionally one or more adjectives that modify the one or more nouns. In some cases, the entity phrase includes a contiguous set of words. In some cases, the text prompt includes one or more words following the entity phrase.

Natural language processing (NLP) refers to techniques for using computers to interpret or generate natural language. In some cases, NLP tasks involve assigning annotation data such as grammatical information to words or phrases within a natural language expression. Different classes of machine-learning algorithms have been applied to NLP tasks. Some algorithms, such as decision trees, utilize hard if-then rules. Other systems use neural networks or statistical models which make soft, probabilistic decisions based on attaching real-valued weights to input features. These models can express the relative probability of multiple answers.

For example, entity marking model 315 may comprise a transformer pipeline. According to some aspects, a transformer comprises one or more ANNs comprising attention mechanisms that enable the transformer to weigh an importance of different words or tokens within a sequence. In some examples, a transformer processes entire sequences simultaneously in parallel, making the transformer highly efficient and allowing the transformer to capture long-range dependencies more effectively.

According to some aspects, a transformer comprises an encoder-decoder structure. The encoder of the transformer processes an input sequence and encodes the input sequence into a set of high-dimensional representations. The decoder of the transformer generates an output sequence based on the encoded representations and previously generated tokens. The encoder and the decoder each include one or more layers of self-attention mechanisms and feed-forward ANNs.

The self-attention mechanism allows the transformer to focus on different parts of an input sequence while computing representations for the input sequence. The self-attention mechanism captures relationships between words of a sequence by assigning attention weights to each word based on a relevance to other words in the sequence, thereby enabling the transformer to model dependencies regardless of a distance between words.

An attention mechanism is a key component in some ANN architectures, particularly ANNs employed in NLP and sequence-to-sequence tasks, which allows an ANN to focus on different parts of an input sequence when making predictions or generating output. According to some aspects, an ANN employing an attention mechanism receives an input sequence and maintains the current state, which represents an understanding or context. For each element in the input sequence, the attention mechanism computes an attention score that indicates the importance or relevance of that element given the current state.

The attention scores are transformed into attention weights through a normalization process, such as applying a softmax function. The attention weights represent the contribution of each input element to the overall attention. The attention weights are used to compute a weighted sum of the input elements, resulting in a context vector. The context vector represents the attended information or the part of the input sequence that the ANN considers most relevant for the current step. The context vector is combined with the current state of the ANN, providing additional information and influencing subsequent predictions or decisions of the ANN.

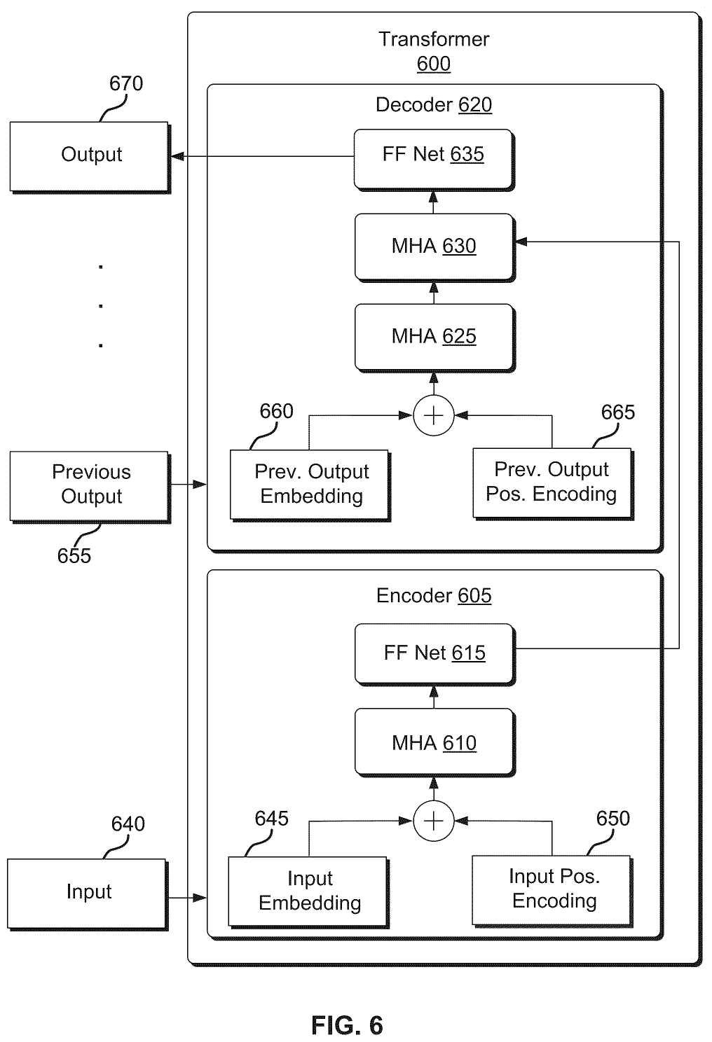

By incorporating an attention mechanism, an ANN dynamically allocates attention to different parts of the input sequence, allowing the ANN to focus on relevant information and capture dependencies across longer distances. A transformer is described in further detail with reference to FIG. 6.

According to some aspects, the transformer pipeline comprises a transformer, a tagger, a dependency parser, an attribute ruler, a lemmatizer, an entity recognizer, or a combination thereof. The transformer of the transformer pipeline outputs a tokenized representation of the text prompt. The tagger is a machine learning model that predicts part-of-speech tags for the tokenized representation. The dependency parser is a machine learning model that jointly learns sentence segmentation and labelled dependency parsing, and can optionally learn to merge tokens that have been over-segmented by the transformer. The attribute ruler is a machine learning model that sets token attributes. The lemmatizer is a component that assigns base forms to tokens using rules based on part-of-speech tags, or lookup tables. The entity recognizer is a transition-based named entity recognition component that identifies non-overlapping labelled spans of tokens in the tokenized representation.

According to some aspects, entity marking model 315 marks the entity phrase within the text prompt by inserting a first tag (e.g., first tag 345) before the entity phrase and a second tag (e.g., second tag 350) after the entity phrase to obtain a revised prompt (e.g., revised prompt 340). In the example of FIG. 3, entity marking model 315 identifies the text string “parallel universe” of text prompt 330 as entity phrase 335, inserts first tag 345 (“<r>”) before entity phrase 335, and inserts second tag 350 (“<er>”) after entity phrase 335 within text prompt 330 to obtain revised prompt 340. In the example of FIG. 3, entity marking model 315 also identifies “gravity” as an additional entity phrase and similarly marks the additional entity phrase.

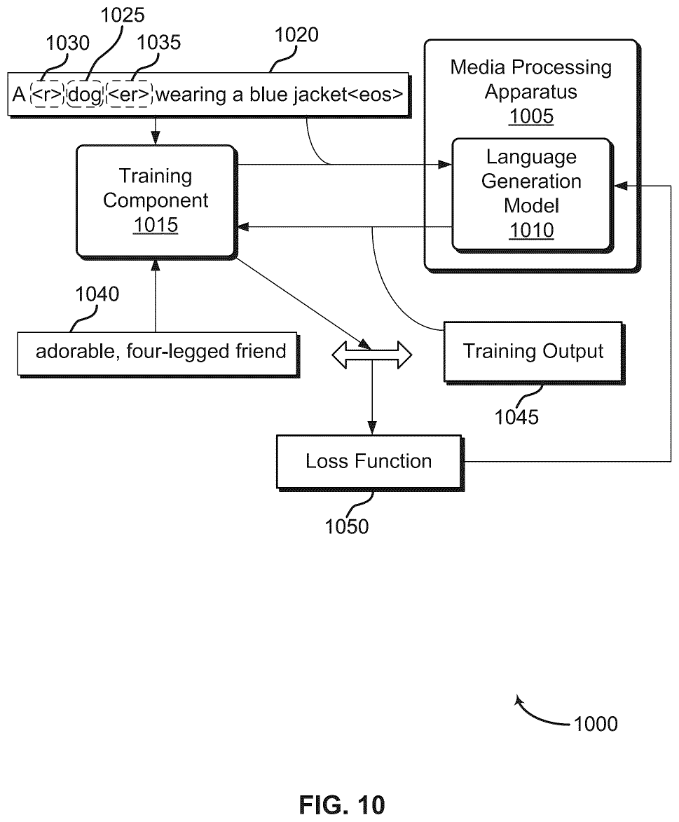

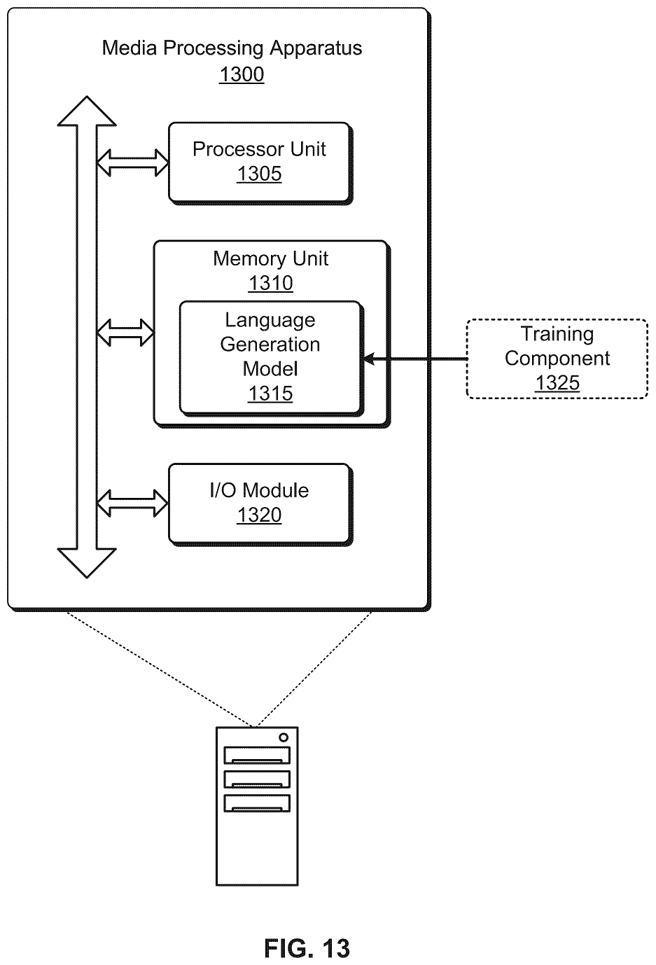

According to some aspects, entity marking model 315 comprises entity marking parameters (e.g., machine learning parameters) stored in memory unit 1310 as described with reference to FIG. 13. Entity phrase 335 is an example of, or includes aspects of, the corresponding element described with reference to FIG. 1. First tag 345 and second tag 350 are examples of, or include aspects of, the corresponding elements described with reference to FIG. 10.

According to some aspects, language generation model 320 generates a replacement phrase (such as replacement phrase 355) by performing autoregressive token generation based on a sequence of tokens from the revised prompt. According to some aspects, user interface 310 receives a selection of the entity phrase included in the text prompt, and language generation model 320 generates the replacement phrase in response to the selection. According to some aspects, the replacement phrase includes a variant of the entity phrase. For example, the replacement phrase can refer to a semantic entity that is similar to the semantic entity referred to by the entity phrase.

According to some aspects, language generation model 320 comprises a large language model comprising one or more transformers (such as the transformer described with reference to FIG. 6). A large language model is a machine learning model that is trained to generate text based on an input.

A conventional large language model employs an autoregressive token generation technique. For example, when a large language model predicts a next token to be generated, the large language model attends to (i.e., uses as context) past tokens that have either been passed in as an instruction or have been previously generated by the large language model. Therefore, for a scenario in which a phrase is to be replaced in an input sentence, conventional large language models are only able to attend to words preceding the phrase, and not to words following the phrase, and therefore cannot generate a replacement for the phrase based on a context of the sentence as a whole.

According to some aspects, language generation model 320 generates the replacement phrase by performing autoregressive token generation based on a sequence of tokens from the revised prompt. In some examples, language generation model 320 is trained to understand that, for a given input sequence (e.g., a revised prompt), a first tag and a second tag surround an entity phrase that is meant to be replaced, and that a replacement phrase for the entity phrase should be generated by attending to every token of the input sequence up to the end-of-sequence tag (e.g., “<eos>”), including tokens that follow the second tag. For example, by using the first tag and the second tag as proxies for tagged phrases in the input sequence, language generation model 320 is able to look backwards (attend to previous tokens) but also consume a full context of the input sequence before generating the replacement phrase.

Accordingly, language generation model 320 is able to generate replacement phrases for an entity phrase that use an entire sentence as context, thereby allowing a meaning of the replacement phrase to better match a meaning of the sentence as compared to conventional large language models.

The variance of the replacement phrase from the entity phrase may be conditioned on the training of language generation model 320, where the type and amount of variation is controlled by the training data. In the example of FIG. 3, language generation model 320 determines that replacement phrase 355 (“alternate dimension”) is an appropriate variant of entity phrase 335 (“parallel universe”) given the training data and the full context of revised prompt 340.

Language generation model 320 is an example of, or includes aspects of, the corresponding element described with reference to FIGS. 10 and 13. According to some aspects, language generation model 320 comprises text generation parameters (e.g., machine learning parameters) stored in memory unit 1310 as described with reference to FIG. 13. Replacement phrase 355 is an example of, or includes aspects of, the corresponding element described with reference to FIGS. 1, 4, and 5.

According to some aspects, augmentation component 325 generates an augmented prompt (e.g., augmented prompt 360) that includes the replacement phrase. For example, augmentation component 325 replaces the entity phrase with the replacement phrase in the text prompt to obtain the augmented prompt. In the example of FIG. 3, augmentation component 325 replaces entity phrase 335 with replacement phrase 355 in text prompt 330 to obtain augmented prompt 360. Augmentation component 325 is an example of, or includes aspects of, the corresponding element described with reference to FIGS. 4 and 5. According to some aspects, augmentation component 325 is implemented as software stored in memory unit 1310 and executable by processor unit 1305 as described with reference to FIG. 13, as firmware of media processing apparatus 305, as at least one hardware circuit of media processing apparatus 305, or as a combination thereof. Augmented prompt 360 is an example of, or includes aspects of, the corresponding element described with reference to FIGS. 1, 4, and 5.

User interface 310 may display the augmented prompt. Media processing apparatus 305 may generate a media item (such as an image) based on the augmented prompt, as described with reference to FIG. 4. Media processing apparatus 305 may retrieve a media item based on the augmented prompt, as described with reference to FIG. 5.

FIG. 4 shows an example of a media processing system 400 for generating a synthetic image based on an augmented prompt according to aspects of the present disclosure. The example shown includes media processing system 400, augmented prompt 425, and synthetic image 435.

Media processing system 400 is an example of, or includes aspects of, the corresponding element described with reference to FIGS. 1, 3, 5, and 10. In one aspect, media processing system 400 includes media processing apparatus 405. Media processing apparatus 405 is an example of, or includes aspects of, the corresponding element described with reference to FIGS. 1, 3, 5, 10, and 13.

In one aspect, media processing apparatus 405 includes augmentation component 410, image generation model 415, and user interface 420. Augmentation component 410 is an example of, or includes aspects of, the corresponding element described with reference to FIGS. 3 and 5. User interface 420 is an example of, or includes aspects of, the corresponding element described with reference to FIGS. 1, 3, 5, and 8.

Referring to FIG. 4, according to some aspects, media processing apparatus 405 generates a media item (e.g., synthetic image 435) based on an augmented prompt (e.g., augmented prompt 425) including a replacement phrase (e.g., replacement phrase 430). In the example of FIG. 4, augmentation component 410 provides augmented prompt 425 to image generation model 415, and image generation model 415 generates synthetic image 435 based on augmented prompt 425. Synthetic image 435 depicts an entity (e.g., alternate dimension) described by replacement phrase 430. User interface 420 may display synthetic image 435.

According to some aspects, image generation model 415 comprises a machine learning model trained to generate a synthetic image based on a text input. For example, image generation model 415 may comprise a diffusion model, a generative adversarial network (GAN), or other suitable machine learning model. A diffusion model transforms an initial random noise input into a coherent and realistic image through an iterative denoising process conditioned on the input text. A GAN iteratively outputs images based on the input text using a generator network until a discriminator network is unable to identify the most recently generated image as being a generated image.

According to some aspects, image generation model 415 comprises image generation parameters (e.g., machine learning parameters) stored in the memory unit 1310 as described with reference to FIG. 13. Augmented prompt 425 is an example of, or includes aspects of, the corresponding element described with reference to FIGS. 1, 3, and 5. Replacement phrase 430 is an example of, or includes aspects of, the corresponding element described with reference to FIGS. 1, 3, and 5.

FIG. 5 shows an example of a media processing system 500 for retrieving a media item 540 based on an augmented prompt 530 according to aspects of the present disclosure. The example shown includes media processing system 500, augmented prompt 530, and media item 540.

Media processing system 500 is an example of, or includes aspects of, the corresponding element described with reference to FIGS. 1, 3, 4, and 10. In one aspect, media processing system 500 includes media processing apparatus 505 and database 525. Media processing apparatus 505 is an example of, or includes aspects of, the corresponding element described with reference to FIGS. 1, 3, 4, 10, and 13.

In one aspect, media processing apparatus 505 includes augmentation component 510, retrieval component 515, and user interface 520. Augmentation component 510 is an example of, or includes aspects of, the corresponding element described with reference to FIGS. 3 and 4. User interface 520 is an example of, or includes aspects of, the corresponding element described with reference to FIGS. 1, 3, 4, and 8. Database 525 is an example of, or includes aspects of, the corresponding element described with reference to FIG. 1.

Referring to FIG. 5, according to some aspects, media processing apparatus 505 retrieves a media item (e.g., media item 540, such as text, an image, a video, audio, etc.) based on an augmented prompt (e.g., augmented prompt 530) including a replacement phrase (e.g., replacement phrase 535) from a database (e.g., database 525). In the example of FIG. 5, augmentation component 510 provides augmented prompt 530 to retrieval component 515, and retrieval component 515 retrieves media item 540 from database 525 based on augmented prompt 530. User interface 520 may display media item 540.

According to some aspects, retrieval component 515 retrieves the media item by matching the augmented prompt to the media item, or an associated description of the media item. In some cases, retrieval component 515 generates a prompt embedding of the augmented prompt (e.g., a vector representation of the augmented prompt in an embedding space) and retrieves the media item by finding a media item embedding (e.g., a vector representation of the media item in the embedding space) that is similar to the prompt embedding and identifying the media item that corresponds to the similar media item embedding.

According to some aspects, retrieval component 515 is implemented as software stored in memory unit 1310 and executable by processor unit 1305 as described with reference to FIG. 13, as firmware of media processing apparatus 505, as at least one hardware circuit of media processing apparatus 505, or as a combination thereof. Augmented prompt 530 and replacement phrase 535 are examples of, or include aspects of, the corresponding elements described with reference to FIGS. 1, 3, and 4.

FIG. 6 shows an example of a transformer according to aspects of the present disclosure. The example shown includes transformer 600, encoder 605, decoder 620, input 640, input embedding 645, input positional encoding 650, previous output 655, previous output embedding 660, previous output positional encoding 665, and output 670. Transformer 600 is an example of a transformer that may be implemented in the entity marking model 315 and/or the language generation model 320 described with reference to FIG. 3.

In the example of FIG. 6, encoder 605 includes multi-head self-attention sublayer 610 and feed-forward network sublayer 615. Decoder 620 includes first multi-head self-attention sublayer 625, second multi-head self-attention sublayer 630, and feed-forward network sublayer 635.

Encoder 605 is configured to map input 640 to a sequence of continuous representations that are fed into decoder 620. Decoder 620 generates output 670 (e.g., a prediction of an output sequence of words or tokens) based on the output of encoder 605 and previous output 655 (e.g., a previously predicted output sequence), which allows for the use of autoregression.

Encoder 605 parses input 640 into tokens and vectorizes the parsed tokens to obtain input embedding 645, and adds input positional encoding 650 (e.g., positional encoding vectors for input 640 of a same dimension as input embedding 645) to input embedding 645. Input positional encoding 650 includes information about relative positions of words or tokens in input 640.

Encoder 605 comprises one or more encoding layers (e.g., six encoding layers) that generate contextualized token representations, where each representation corresponds to a token that combines information from other input tokens via self-attention mechanism. Each encoding layer of encoder 605 comprises a multi-head self-attention sublayer (e.g., multi-head self-attention sublayer 610). The multi-head self-attention sublayer implements a multi-head self-attention mechanism that receives different linearly projected versions of queries, keys, and values to produce outputs in parallel. Each encoding layer of encoder 605 also includes a fully connected feed-forward network sublayer (e.g., feed-forward network sublayer 615) comprising two linear transformations surrounding a Rectified Linear Unit (ReLU) activation:

$$FFN ( x ) = ReLU ( {W}_{1} x + {b}_{1} ) {W}_{2} + {b}_{2} \qquad ( 1 )$$

Each layer employs different weight parameters (W₁, W₂) and different bias parameters (b₁, b₂) to apply a same linear transformation to each word or token in input 640.

Each sublayer of encoder 605 is followed by a normalization layer that normalizes a sum computed between a sublayer input x and an output sublayer (x) generated by the sublayer:

$$layernorm ( x + sublayer ( x ) ) \qquad ( 2 )$$

Encoder 605 is bidirectional because encoder 605 attends to each word or token in input 640 regardless of a position of the word or token in input 640. Decoder 620 comprises one or more decoding layers (e.g., six decoding layers). Each decoding layer comprises three sublayers including a first multi-head self-attention sublayer (e.g., first multi-head self-attention sublayer 625), a second multi-head self-attention sublayer (e.g., second multi-head self-attention sublayer 630), and a feed-forward network sublayer (e.g., feed-forward network sublayer 635). Each sublayer of decoder 620 is followed by a normalization layer that normalizes a sum computed between a sublayer input x and an output sublayer (x) generated by the sublayer.

Decoder 620 generates previous output embedding 660 of previous output 655 and adds previous output positional encoding 665 (e.g., position information for words or tokens in previous output 655) to previous output embedding 660. Each first multi-head self-attention sublayer receives the combination of previous output embedding 660 and previous output positional encoding 665 and applies a multi-head self-attention mechanism to the combination.

Each second multi-head self-attention sublayer implements a multi-head self-attention mechanism similar to the multi-head self-attention mechanism implemented in each multi-head self-attention sublayer of encoder 605 by receiving a query Q from a previous sublayer of decoder 620 and a key K and a value V from the output of encoder 605.

Each feed-forward network sublayer implements a fully connected feed-forward network similar to feed-forward network sublayer 615. The feed-forward network sublayers are followed by a linear transformation and a softmax to generate a prediction of output 670 (e.g., a prediction of a next word or token in a sequence of words or tokens).

### Media Processing

A method for media processing is described with reference to FIGS. 7-8. FIG. 7 shows an example of a method 700 for generating an augmented prompt according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

Referring to FIG. 7, according to some aspects, a media processing system (such as the media processing system described with reference to FIG. 1) generates a replacement phrase for an entity phrase included in a text prompt, and generates an augmented prompt by replacing the entity phrase with the replacement phrase. The replacement phrase may be more descriptive than the entity phrase, and therefore a better media item (such as an image) may be generated or retrieved based on the augmented prompt than on the text prompt.

According to some aspects, a language generation model (such as the language generation model 320 described with reference to FIG. 3) generates the replacement phrase by performing autoregressive token generation based on a sequence of tokens included in a revised prompt provided by an entity marking model (such as the entity marking model 315 described with reference to FIG. 3).

A conventional large language model employs an autoregressive token generation technique. For example, when a large language model predicts a next token to be generated, the large language model attends to (i.e., uses as context) past tokens that have either been passed in as an instruction or have been previously generated by the large language model. Therefore, for a scenario in which a phrase is to be replaced in an input sentence, conventional large language models are only able to attend to words preceding the phrase, and not to words following the phrase, and therefore cannot generate a replacement for the phrase based on a context of the sentence as a whole.

According to some aspects, the language generation model generates the replacement phrase by performing autoregressive token generation based on a sequence of tokens from the revised prompt. In some examples, the language generation model is trained to understand that, for a given input sequence (e.g., the revised prompt), a first tag and a second tag surround an entity phrase that is meant to be replaced, and that a replacement phrase for the entity phrase should be generated by attending to every token of the input sequence up to an end-of-sequence tag (e.g., “<eos>”). For example, by using the first tag and the second tag as proxies for tagged phrases in the input sequence, the language generation model is able to look backwards (attend to previous tokens) but also consume a full context of the input sequence before generating the replacement phrase.

Accordingly, the language generation model is able to generate replacement phrases for an entity phrase that use an entire sentence as context, thereby allowing a meaning of the replacement phrase to better match a meaning of the sentence as compared to conventional large language models.

At operation 705, the system receives a text prompt including an entity phrase. In some cases, the operations of this step refer to, or may be performed by, a user interface as described with reference to FIGS. 1, 3-5, and 8. For example, the user interface receives the text prompt as described with reference to FIG. 3.

At operation 710, the system marks the entity phrase within the text prompt to obtain a revised prompt. In some cases, the operations of this step refer to, or may be performed by, an entity marking model as described with reference to FIG. 3. For example, the entity marking model obtains the revised prompt as described with reference to FIG. 3.

At operation 715, the system generates, using a language generation model, a replacement phrase by performing autoregressive token generation based on a sequence of tokens from the revised prompt, where the replacement phrase includes a variant of the entity phrase. In some cases, the operations of this step refer to, or may be performed by, a language generation model as described with reference to FIGS. 3, 10, and 13. For example, the language generation model generates the replacement phrase as described with reference to FIG. 3.

At operation 720, the system generates an augmented prompt that includes the replacement phrase. In some cases, the operations of this step refer to, or may be performed by, an augmentation component as described with reference to FIGS. 3-5. For example, the augmentation component generates the augmented prompt as described with reference to FIG. 3.

FIG. 8 shows an example of a user interface for displaying an augmented prompt according to a prompt augmentation method according to aspects of the present disclosure. The example shown includes user interface 800, first entity phrase 820, second entity phrase 825, first replacement phrase 830, second replacement phrase 835, third replacement phrase 840, fourth replacement phrase 845, fifth replacement phrase 850, and sixth replacement phrase 855.

User interface 800 is an example of, or includes aspects of, the corresponding element described with reference to FIGS. 1 and 3-5. In one aspect, user interface 800 includes prompt element 805, phrase replacement element 810, and refresh element 815. Prompt element 805 is an example of, or includes aspects of, the corresponding element described with reference to FIG. 1.

Referring to FIG. 8, a prompt element (such as prompt element 805) of a user interface (such as user interface 800) may display a text prompt received from a user and may highlight one or more entity phrases (such as first entity phrase 820 and second entity phrase 825) included in the text prompt. A user may provide an input to one of the highlighted entity phrases (e.g., first entity phrase 820) to see a display, in a phrase replacement element (e.g., phrase replacement element 810), of one or more replacement phrases (e.g., first replacement phrase 830, second replacement phrase 835, and third replacement phrase 840) generated by a language generation model (such as the language generation model 320 described with reference to FIG. 3) for the highlighted entity phrase.

A user may provide an input to select one of the displayed replacement phrases. An augmentation component (such as the augmentation component 325 described with reference to FIG. 3) may generate an augmented prompt by replacing the highlighted entity phrase with the selected replacement phrase (e.g., first replacement phrase 830). An entity marking model (such as the entity marking model 315 described with reference to FIG. 3) may identify the replacement phrase as an entity phrase and surround the replacement phrase with a first tag and a second tag to obtain an additional revised prompt.

A user may request the language generation model to generate an additional set of replacement phrases by providing an input to a refresh element (e.g., refresh element 815) of the user interface. The refresh element displays the additional set of replacement phrases.

Where prompt element 805 displays an augmented prompt, a user may provide an input to an additional highlighted entity phrase (e.g., second entity phrase 825) included in the augmented prompt to see a display, in the phrase replacement element, of one or more additional replacement phrases (e.g., fourth replacement phrase 845, fifth replacement phrase 850, and sixth replacement phrase 855) generated by the language generation model (such as the language generation model 320 described with reference to FIG. 3) for the highlighted entity phrase based on the context of the additional revised prompt.

The augmentation component may generate an additional augmented prompt including a selected additional replacement phrases (e.g., fifth replacement phrase 850) and the prompt element may display the additional augmented prompt (e.g., the additional augmented prompt including highlights of first replacement phrase 830 and fifth replacement phrase 850, which are identified as entity phrases).

Accordingly, a method for media processing is described. One or more aspects of the method include receiving a text prompt including an entity phrase; marking the entity phrase within the text prompt to obtain a revised prompt; generating, using a language generation model, a replacement phrase by performing autoregressive token generation based on a sequence of tokens from the revised prompt, wherein the replacement phrase comprises a variant of the entity phrase; and generating an augmented prompt that includes the replacement phrase. In some aspects, the text prompt includes one or more words following the entity phrase.

Some examples of the method further include identifying, using a natural language processing model, the entity phrase from the text prompt. Some examples further include marking the entity phrase within the text prompt by inserting a first tag before the entity phrase and a second tag after the entity phrase. Some examples of the method further include generating a plurality of replacement phrases including the replacement phrase. Some examples further include receiving a user input selecting the replacement phrase from among the plurality of replacement phrases, wherein the augmented prompt is generated based on the user input.

Some examples of the method further include identifying an additional entity phrase in the text prompt. Some examples further include generating an additional replacement phrase for the additional entity phrase, wherein the augmented prompt includes the additional replacement phrase. In some aspects, the additional replacement phrase is generated based on the replacement phrase.

Some examples of the method further include displaying the entity phrase. Some examples further include receiving a selection of the entity phrase. Some examples further include displaying the replacement phrase in response to the selection.

Some examples of the method further include generating, using an image generation model, a synthetic image based on the augmented prompt, wherein the synthetic image depicts an entity described by the replacement phrase. Some examples of the method further include retrieving a media item from a database based on the augmented prompt. Some examples of the method further include receiving a refresh command. Some examples further include generating an additional replacement phrase based on the refresh command.

In some aspects, the language generation model is trained to generate the replacement phrase using a training set including a training text prompt and a training replacement phrase.

### Training

A method for training a machine learning model is described with reference to FIGS. 9-11. FIG. 9 shows an example of a method 900 for training a language generation model according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

Referring to FIG. 9, a language generation model (such as the language generation model 1010 described with reference to FIG. 10) is trained to understand that, for a given input sequence (e.g., a revised prompt), a first tag and a second tag surround an entity phrase that is meant to be replaced, and that a replacement phrase for the entity phrase should be generated by attending to every token of the input sequence up to an end-of-sequence tag (e.g., “<eos>”) For example, by using the first tag and the second tag as proxies for tagged phrases in the input sequence, the trained language generation model is able to look backwards (attend to previous tokens) but also consume a full context of the input sequence before generating the replacement phrase.

Accordingly, the trained language generation model is able to generate replacement phrases for an entity phrase that use an entire sentence as context, thereby allowing a meaning of the replacement phrase to better match a meaning of the sentence as compared to conventional large language models.

At operation 905, the system obtains a training set including a training text prompt and a training replacement phrase, where the training text prompt includes a training entity phrase surrounded by a first tag and a second tag, and the training replacement phrase includes a ground-truth variant of the training entity phrase. In some cases, the operations of this step refer to, or may be performed by, a training component as described with reference to FIGS. 10 and 13.

In an example, the training component retrieves the training set from a database (such as the database 135 described with reference to FIG. 1). An entity marking model (such as the entity marking model 315 described with reference to FIG. 3) may identify the training entity phrase in the training text prompt and insert the first tag before the training entity phrase and the second tag after the training entity phrase.

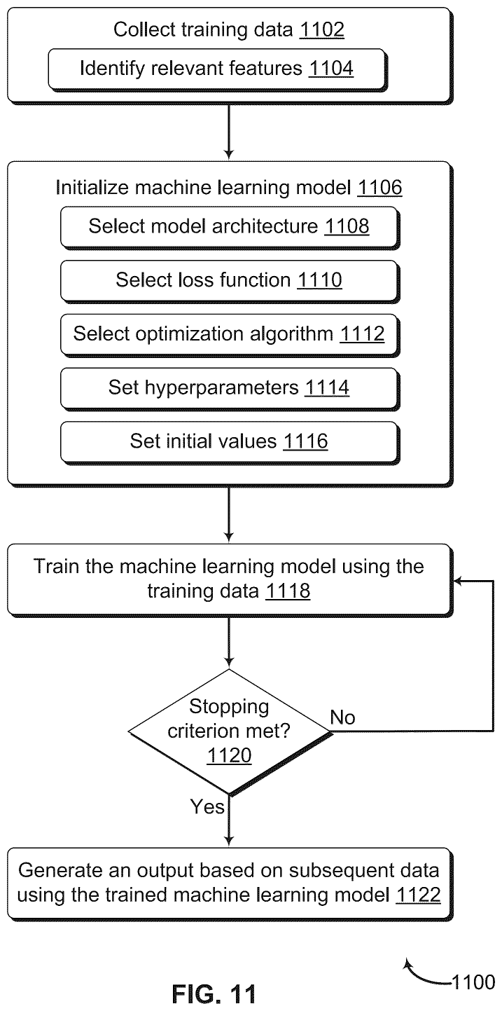

At operation 910, the system trains, using the training set, a language generation model to generate a replacement phrase based on a text prompt, where the replacement phrase includes a variant of an entity phrase in the text prompt. In some cases, the operations of this step refer to, or may be performed by, a training component as described with reference to FIGS. 10 and 13. In an example, the training component trains the language generation model as described with reference to FIGS. 10 and 11.

FIG. 10 shows an example of a media processing system 1000 for training a language generation model 1010 according to aspects of the present disclosure. The example shown includes media processing system 1000, training text prompt 1020, training replacement phrase 1040, training output 1045, and loss function 1050.

Media processing system 1000 is an example of, or includes aspects of, the corresponding element described with reference to FIGS. 1, and 3-5. In one aspect, media processing system 1000 includes media processing apparatus 1005 and training component 1015. Media processing apparatus 1005 is an example of, or includes aspects of, the corresponding element described with reference to FIGS. 1, 3-5, and 13. Training component 1015 is an example of, or includes aspects of, the corresponding element described with reference to FIG. 13.

In one aspect, media processing apparatus 1005 includes language generation model 1010. Language generation model 1010 is an example of, or includes aspects of, the corresponding element described with reference to FIGS. 3 and 13.

According to some aspects, training component 1015 obtains a training set including a training text prompt (e.g., training text prompt 1020) and a training replacement phrase (e.g., training replacement phrase 1040), where the training text prompt includes a training entity phrase (e.g., training entity phrase 1025) surrounded by a first tag (e.g., first tag 1030) and a second tag (e.g., second tag 1035), and the training replacement phrase includes a ground-truth variant of the training entity phrase. First tag 1030 and second tag 1035 are examples of, or include aspects of, the corresponding element described with reference to FIG. 3. According to some aspects, an entity marking model (such as entity marking model 315 described with reference to FIG. 3) inserts the first tag before the training entity phrase and the second tag after the training entity phrase.

In some examples, training component 1015 trains, using the training set, language generation model 1010 to generate a replacement phrase based on a text prompt, where the replacement phrase includes a variant of an entity phrase in the text prompt. For example, language generation model 1010 generates the training output based on the training text prompt, training component 1015 computes a loss function (e.g., loss function 1050) based on the training output and the training replacement phrase, and training component 1015 updates parameters of language generation model 1010 based on the loss function.

The term “loss function” refers to a function that impacts how a machine learning model is trained in a supervised learning model. Specifically, during each training iteration, the output of the model is compared to the known annotation information in the training data. The loss function provides a value (a “loss”) for how close the predicted annotation data is to the actual annotation data. After computing the loss, the parameters of the model are updated accordingly and a new set of predictions are made during the next iteration. According to some aspects, the loss function measures a similarity between the training output and the training replacement phrase. A loss function and updating parameters of a machine learning model based on a loss function is described in further detail with reference to FIG. 11.

In the example of FIG. 10, language generation model 1010 generates training output 1045 based on a training text prompt 1020 that includes training entity phrase 1025 (“dog”), first tag 1030, second tag 1035, and an end-of-sequence (“<eos>”) tag. Training component 1015 compares training output 1045 with training replacement phrase 1040 (“adorable, four-legged friend”) to determine loss function 1050 and updates parameters of language generation model 1010 based on loss function 1050. This process iteratively repeats until language generation model 1010 outputs “adorable, four-legged friend” as training output 1045.

Other example replacement phrases for training text prompt 1020 (“A<r> dog <er> wearing a blue jacket<eos>”) that may be included in the training set include “loyal, furry companion” and “adorable, four-legged friend” (e.g., additional ground-truth variants of the training entity phrase). By updating parameters of the language generation model based on the loss function, the language generation model learns to generate replacement phrases for tagged entity phrases included in an input prompt, using the whole input prompt as context for the generation.

The language generation model is not limited to generating specific replacement phrases that it has been specifically trained on (e.g., a language generation model trained according to FIG. 10 is not limited to generating “adorable, four-legged friend” as a replacement phrase for an input sequence including a “dog” entity phrase), and is not limited to generating replacement phrases only for specific entity phrases that is has been trained on. Instead, the method illustrated by FIG. 10 allows a trained language generation model to generate any context-appropriate replacement phrase for any tagged entity phrase.

According to some aspects, the language generation model comprises a pre-trained large language model, and the training component trains the language generation model by fine-tuning the pre-trained large language model based on the loss function. In some cases, the training component fine-tunes the pre-trained large language model using low-rank adaptation, which freezes the pre-trained large language model weights and injects trainable rank decomposition matrices into each layer of the transformer architecture of the pre-trained large language model, greatly reducing a number of trainable parameters for downstream tasks. In some cases, low-rank adaptation allows the pre-trained large language model to be fine-tuned without having to modify base model weights of the pre-trained large language model, allowing multiple use cases of the pre-trained large language model to be fine-tuned in parallel.

FIG. 11 shows an example of a flow diagram depicting an algorithm as a step-by-step procedure 1100 for training a machine learning model according to aspects of the present disclosure. In some embodiments, the procedure 1100 describes an operation of the training component 1325 described for configuring the machine learning model (e.g., language generation model 1315) as described with reference to FIG. 13. The procedure 1100 provides one or more examples of generating training data, use of the training data to train a machine-learning model, and use of the trained machine-learning model to perform a task.

To begin in this example, a machine-learning system collects training data (block 1102) that is to be used as a basis to train a machine-learning model, i.e., which defines what is being modeled. The training data is collectable by the machine-learning system from a variety of sources. Examples of training data sources include public datasets, service provider system platforms that expose application programming interfaces (e.g., social media platforms), user data collection systems (e.g., digital surveys and online crowdsourcing systems), and so forth. Training data collection may also include data augmentation and synthetic data generation techniques to expand and diversify available training data, balancing techniques to balance a number of positive and negative examples, and so forth.

The machine-learning system is also configurable to identify features that are relevant (block 1104) to a type of task, for which the machine-learning model is to be trained. Task examples include classification, natural language processing, generative artificial intelligence, recommendation engines, reinforcement learning, clustering, and so forth. To do so, the machine-learning system collects the training data based on the identified features and/or filters the training data based on the identified features after collection. The training data is then utilized to train a machine-learning model.

In order to train the machine-learning model in the illustrated example, the machine-learning model is first initialized (block 1106). Initialization of the machine-learning model includes selecting a model architecture (block 1108) to be trained. Examples of model architectures include neural networks, convolutional neural networks (CNNs), long short-term memory (LSTM) neural networks, generative adversarial networks (GANs), decision trees, support vector machines, linear regression, logistic regression, Bayesian networks, random forest learning, dimensionality reduction algorithms, boosting algorithms, deep learning neural networks, etc.

A loss function is also selected (block 1110). The loss function is utilized to measure a difference between an output of the machine-learning model (i.e., predictions) and target values (e.g., as expressed by the training data) to be used to train the machine-learning model. Additionally, an optimization algorithm is selected (1112) that is to be used in conjunction with the loss function to optimize parameters of the machine-learning model during training, examples of which include gradient descent, stochastic gradient descent (SGD), and so forth.

Initialization of the machine-learning model further includes setting initial values of the machine-learning model (block 1114), examples of which includes initializing weights and biases of nodes to improve efficiency in training and computational resources consumption as part of training. Hyperparameters are also set that are used to control training of the machine learning model, examples of which include regularization parameters, model parameters (e.g., a number of layers in a neural network), learning rate, batch sizes selected from the training data, and so on. The hyperparameters are set using a variety of techniques, including use of a randomization technique, through use of heuristics learned from other training scenarios, and so forth.

The machine-learning model is then trained using the training data (block 1118) by the machine-learning system. A machine-learning model refers to a computer representation that can be tuned (e.g., trained and retrained) based on inputs of the training data to approximate unknown functions. In particular, the term machine-learning model can include a model that utilizes algorithms (e.g., using the model architectures described above) to learn from, and make predictions on, known data by analyzing training data to learn and relearn to generate outputs that reflect patterns and attributes expressed by the training data.

Examples of training types include supervised learning that employs labeled data, unsupervised learning that involves finding an underlying structures or patterns within the training data, reinforcement learning based on optimization functions (e.g., rewards and/or penalties), use of nodes as part of “deep learning,” and so forth. The machine-learning model, for instance, is configurable as including a plurality of nodes that collectively form a plurality of layers. The layers, for instance, are configurable to include an input layer, an output layer, and one or more hidden layers. Calculations are performed by the nodes within the layers through the hidden states through a system of weighted connections that are “learned” during training, e.g., through use of the selected loss function and backpropagation to optimize performance of the machine-learning model to perform an associated task.

As part of training the machine-learning model, a determination is made as to whether a stopping criterion is met (decision block 1120), i.e., which is used to validate the machine-learning model. The stopping criterion is usable to reduce overfitting of the machine-learning model, reduce computational resource consumption, and promote an ability of the machine-learning model to address previously unseen data, i.e., that is not included specifically as an example in the training data. Examples of a stopping criterion include but are not limited to a predefined number of epochs, validation loss stabilization, achievement of a performance improvement threshold, whether a threshold level of accuracy has been met, or based on performance metrics such as precision and recall. If the stopping criterion has not been met (“no” from decision block 1120), the procedure 1100 continues training of the machine-learning model using the training data (block 1118) in this example.

If the stopping criterion is met (“yes” from decision block 1120), the trained machine-learning model is then utilized to generate an output based on subsequent data (block 1122). The trained machine-learning model, for instance, is trained to perform a task as described above and therefore once trained is configured to perform that task based on subsequent data received as an input and processed by the machine-learning model.

Accordingly, a method for training a machine learning model is described. One or more aspects of the method include obtaining a training set including a training text prompt and a training replacement phrase, wherein the training text prompt includes a training entity phrase surrounded by a first tag and a second tag, and the training replacement phrase comprises a ground-truth variant of the training entity phrase and training, using the training set, a language generation model to generate a replacement phrase based on a text prompt, wherein the replacement phrase comprises a variant of an entity phrase in the text prompt.

Some examples of the method further include identifying the training entity phrase in the training text prompt. Some examples further include inserting the first tag before the training entity phrase and the second tag after the training entity phrase.

Some examples of the method further include generating, using the language generation model, a training output based on the training text prompt. Some examples further include computing a loss function based on the training output and the training replacement phrase. Some examples further include updating parameters of the language generation model based on the loss function. Some examples of the method further include obtaining an additional replacement phrase comprising an additional variant of the training entity phrase.

### Computing Device

FIG. 12 shows an example of a computing device 1200 according to aspects of the present disclosure. The computing device 1200 may be an example of the media processing apparatus 1300 described with reference to FIG. 13. In one aspect, computing device 1200 includes processor(s) 1205, memory subsystem 1210, communication interface 1215, I/O interface 1220, user interface component(s) 1225, and channel 1230. In some embodiments, computing device 1200 includes one or more processors 1205 that can execute instructions stored in memory subsystem 1210 to perform media generation.

According to some aspects, computing device 1200 includes one or more processors 1205. In some cases, a processor is an intelligent hardware device, (e.g., a general-purpose processing component, a digital signal processor (DSP), a central processing unit (CPU), a graphics processing unit (GPU), a microcontroller, an application specific integrated circuit (ASIC), a field programmable gate array (FPGA), a programmable logic device, a discrete gate or transistor logic component, a discrete hardware component, or a combination thereof. In some cases, a processor is configured to operate a memory array using a memory controller. In other cases, a memory controller is integrated into a processor. In some cases, a processor is configured to execute computer-readable instructions stored in a memory to perform various functions. In some embodiments, a processor includes special purpose components for modem processing, baseband processing, digital signal processing, or transmission processing.

According to some aspects, memory subsystem 1210 includes one or more memory devices. Examples of a memory device include random access memory (RAM), read-only memory (ROM), or a hard disk. Examples of memory devices include solid state memory and a hard disk drive. In some examples, memory is used to store computer-readable, computer-executable software including instructions that, when executed, cause a processor to perform various functions described herein. In some cases, the memory contains, among other things, a basic input/output system (BIOS) which controls basic hardware or software operation such as the interaction with peripheral components or devices. In some cases, a memory controller operates memory cells. For example, the memory controller can include a row decoder, column decoder, or both. In some cases, memory cells within a memory store information in the form of a logical state.

According to some aspects, communication interface 1215 operates at a boundary between communicating entities (such as computing device 1200, one or more user devices, a cloud, and one or more databases) and channel 1230 and can record and process communications. In some cases, communication interface 1215 is provided to enable a processing system coupled to a transceiver (e.g., a transmitter and/or a receiver). In some examples, the transceiver is configured to transmit (or send) and receive signals for a communications device via an antenna.

According to some aspects, I/O interface 1220 is controlled by an I/O controller to manage input and output signals for computing device 1200. In some cases, I/O interface 1220 manages peripherals not integrated into computing device 1200. In some cases, I/O interface 1220 represents a physical connection or port to an external peripheral. In some cases, the I/O controller uses an operating system such as iOS®, ANDROID®, MS-DOS®, MS-WINDOWS®, OS/2®, UNIX®, LINUX®, or other known operating system. In some cases, the I/O controller represents or interacts with a modem, a keyboard, a mouse, a touchscreen, or a similar device. In some cases, the I/O controller is implemented as a component of a processor. In some cases, a user interacts with a device via I/O interface 1220 or via hardware components controlled by the I/O controller.

According to some aspects, user interface component(s) 1225 enable a user to interact with computing device 1200. In some cases, user interface component(s) 1225 include an audio device, such as an external speaker system, an external display device such as a display screen, an input device (e.g., a remote-control device interfaced with a user interface directly or through the I/O controller), or a combination thereof. In some cases, user interface component(s) 1225 include a GUI.

FIG. 13 shows an example implementation of a media processing apparatus according to aspects of the present disclosure. Media processing apparatus 1300 is an example of, or includes aspects of, the corresponding element described with reference to FIGS. 1, 3-5, and 10. In some embodiments, media processing apparatus 1300 includes processor unit 1305, memory unit 1310, language generation model 1315, I/O module 1320, and training component 1325. Training component 1325 updates text generation parameters of language generation model 1315 stored in memory unit 1310. In some examples, the training component 1325 is located outside the media processing apparatus 1300. Training component 1325 is an example of, or includes aspects of, the training component 1015 described with reference to FIG. 10.

Processor unit 1305 includes one or more processors. A processor is an intelligent hardware device, such as a general-purpose processing component, a digital signal processor (DSP), a central processing unit (CPU), a graphics processing unit (GPU), a microcontroller, an application specific integrated circuit (ASIC), a field programmable gate array (FPGA), a programmable logic device, a discrete gate or transistor logic component, a discrete hardware component, or any combination thereof.

In some cases, processor unit 1305 is configured to operate a memory array using a memory controller. In other cases, a memory controller is integrated into processor unit 1305. In some cases, processor unit 1305 is configured to execute computer-readable instructions stored in memory unit 1310 to perform various functions. In some aspects, processor unit 1305 includes special purpose components for modem processing, baseband processing, digital signal processing, or transmission processing. According to some aspects, processor unit 1305 comprises one or more processors described with reference to FIG. 12.

Memory unit 1310 includes one or more memory devices. Examples of a memory device include random access memory (RAM), read-only memory (ROM), or a hard disk. Examples of memory devices include solid state memory and a hard disk drive. In some examples, memory is used to store computer-readable, computer-executable software including instructions that, when executed, cause at least one processor of processor unit 1305 to perform various functions described herein.

In some cases, memory unit 1310 includes a basic input/output system (BIOS) that controls basic hardware or software operations, such as an interaction with peripheral components or devices. In some cases, memory unit 1310 includes a memory controller that operates memory cells of memory unit 1310. For example, the memory controller may include a row decoder, column decoder, or both. In some cases, memory cells within memory unit 1310 store information in the form of a logical state. According to some aspects, memory unit 1310 is an example of the memory subsystem 1210 described with reference to FIG. 12.

According to some aspects, media processing apparatus 1300 uses one or more processors of processor unit 1305 to execute instructions stored in memory unit 1310 to perform functions described herein. For example, the media processing apparatus 1300 may receive a text prompt including an entity phrase; mark the entity phrase within the text prompt to obtain a revised prompt; generate, using a language generation model, a replacement phrase by performing autoregressive token generation based on a sequence of tokens from the revised prompt, wherein the replacement phrase comprises a variant of the entity phrase; and generate an augmented prompt that includes the replacement phrase.

Memory unit 1310 may include a language generation model 1315 trained to generate a replacement phrase based on the revised prompt, wherein the replacement phrase comprises a variant of the entity phrase. For example, after training, language generation model 1315 may perform inferencing operations as described with reference to FIGS. 7-8 to generate a replacement phrase by performing autoregressive token generation based on a sequence of tokens from the revised prompt. Language generation model 1315 is an example of, or includes aspects of, the corresponding element described with reference to FIGS. 3 and 10.

In some embodiments, language generation model 1315 is an artificial neural network (ANN), such as the transformer described with reference to FIG. 6. An ANN can be a hardware component or a software component that includes connected nodes (i.e., artificial neurons) that loosely correspond to the neurons in a human brain. Each connection, or edge, transmits a signal from one node to another (like the physical synapses in a brain). When a node receives a signal, it processes the signal and then transmits the processed signal to other connected nodes.

ANNs have numerous parameters, including weights and biases associated with each neuron in the network, which control the degree of connection between neurons and influence the neural network's ability to capture complex patterns in data. These parameters, also known as model parameters or model weights, are variables that determine the behavior and characteristics of a machine learning model.

In some cases, the signals between nodes comprise real numbers, and the output of each node is computed by a function of its inputs. For example, nodes may determine their output using other mathematical algorithms, such as selecting the max from the inputs as the output, or any other suitable algorithm for activating the node. Each node and edge are associated with one or more node weights that determine how the signal is processed and transmitted. In some cases, nodes have a threshold below which a signal is not transmitted at all. In some examples, the nodes are aggregated into layers.

The parameters of language generation model 1315 can be organized into layers. Different layers perform different transformations on their inputs. The initial layer is known as the input layer and the last layer is known as the output layer. In some cases, signals traverse certain layers multiple times. A hidden (or intermediate) layer includes hidden nodes and is located between an input layer and an output layer. Hidden layers perform nonlinear transformations of inputs entered into the network. Each hidden layer is trained to produce a defined output that contributes to a joint output of the output layer of the ANN. Hidden representations are machine-readable data representations of an input that are learned from hidden layers of the ANN and are produced by the output layer. As the understanding of the ANN of the input improves as the ANN is trained, the hidden representation is progressively differentiated from earlier iterations.

Training component 1325 may train language generation model 1315. For example, parameters of language generation model 1315 can be learned or estimated from training data and then used to make predictions or perform tasks based on learned patterns and relationships in the data. In some examples, the parameters are adjusted during the training process to minimize a loss function or maximize a performance metric (e.g., as described with reference to FIGS. 9-11). The goal of the training process may be to find optimal values for the parameters that allow language generation model 1315 to make accurate predictions or perform well on the given task.

Accordingly, the node weights can be adjusted to improve the accuracy of the output (i.e., by minimizing a loss which corresponds in some way to the difference between the current result and the target result). The weight of an edge increases or decreases the strength of the signal transmitted between nodes. For example, during the training process, an algorithm adjusts machine learning parameters to minimize an error or loss between predicted outputs and actual targets according to optimization techniques like gradient descent, stochastic gradient descent, or other optimization algorithms. Once the machine learning parameters are learned from the training data, language generation model 1315 can be used to make predictions on new, unseen data (i.e., during inference).

I/O module 1320 receives inputs from and transmits outputs of the media processing apparatus 1300 to other devices or users. For example, I/O module 1320 receives inputs for the language generation model 1315 and transmits outputs of the language generation model 1315. According to some aspects, I/O module 1320 is an example of the I/O interface 1220 described with reference to FIG. 12.

Accordingly, a system and an apparatus for media processing are described. One or more aspects of the system and the apparatus include at least one memory; at least one processor executing instructions stored in the at least one memory; an entity marking model comprising entity marking parameters stored in the at least one memory, the entity marking model trained to mark the entity phrase within a text prompt to obtain a revised prompt; and a language generation model comprising text generation parameters stored in the at least one memory, the language generation model trained to generate a replacement phrase based on the revised prompt, wherein the replacement phrase comprises a variant of the entity phrase.

Some examples of the system and apparatus further include an augmentation component configured to generate an augmented prompt that includes the replacement phrase. Some examples of the system and apparatus further include an image generation model comprising image generation parameters stored in the at least one memory, the image generation model configured to generate an image based on the replacement phrase.

Some examples of the system and apparatus further include a retrieval component configured to retrieve a media item from a database based on the replacement phrase. Some examples of the system and apparatus further include a user interface configured to receive a selection of the entity phrase and display the replacement phrase in response to the selection.

The description and drawings described herein represent example configurations and do not represent all the implementations within the scope of the claims. For example, the operations and steps may be rearranged, combined or otherwise modified. Also, structures and devices may be represented in the form of block diagrams to represent the relationship between components and avoid obscuring the described concepts. Similar components or features may have the same name but may have different reference numbers corresponding to different figures.

Some modifications to the disclosure may be readily apparent to those skilled in the art, and the principles defined herein may be applied to other variations without departing from the scope of the disclosure. Thus, the disclosure is not limited to the examples and designs described herein, but is to be accorded the broadest scope consistent with the principles and novel features disclosed herein.

The described methods may be implemented or performed by devices that include a general-purpose processor, a digital signal processor (DSP), an application specific integrated circuit (ASIC), a field programmable gate array (FPGA) or other programmable logic device, discrete gate or transistor logic, discrete hardware components, or any combination thereof. A general-purpose processor may be a microprocessor, a conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Thus, the functions described herein may be implemented in hardware or software and may be executed by a processor, firmware, or any combination thereof. If implemented in software executed by a processor, the functions may be stored in the form of instructions or code on a computer-readable medium.

Computer-readable media includes both non-transitory computer storage media and communication media including any medium that facilitates transfer of code or data. A non-transitory storage medium may be any available medium that can be accessed by a computer. For example, non-transitory computer-readable media can comprise random access memory (RAM), read-only memory (ROM), electrically erasable programmable read-only memory (EEPROM), compact disk (CD) or other optical disk storage, magnetic disk storage, or any other non-transitory medium for carrying or storing data or code.

Also, connecting components may be properly termed computer-readable media. For example, if code or data is transmitted from a website, server, or other remote source using a coaxial cable, fiber optic cable, twisted pair, digital subscriber line (DSL), or wireless technology such as infrared, radio, or microwave signals, then the coaxial cable, fiber optic cable, twisted pair, DSL, or wireless technology are included in the definition of medium. Combinations of media are also included within the scope of computer-readable media.

In this disclosure and the following claims, the word “or” indicates an inclusive list such that, for example, the list of X, Y, or Z means X or Y or Z or XY or XZ or YZ or XYZ. Also the phrase “based on” is not used to represent a closed set of conditions. For example, a step that is described as “based on condition A” may be based on both condition A and condition B. In other words, the phrase “based on” shall be construed to mean “based at least in part on.” Also, the words “a” or “an” indicate “at least one.”

What is claimed is:

1. A method for media processing, comprising:
receiving a text prompt including an entity phrase;
marking the entity phrase within the text prompt to obtain a revised prompt;
generating, using a language generation model, a replacement phrase by performing autoregressive token generation based on a sequence of tokens from the revised prompt, wherein the replacement phrase comprises a variant of the entity phrase; and
generating an augmented prompt that includes the replacement phrase.

2. The method of claim 1, further comprising:
identifying, using a natural language processing model, the entity phrase from the text prompt.

3. The method of claim 1, further comprising:
generating a plurality of replacement phrases including the replacement phrase; and
receiving a user input selecting the replacement phrase from among the plurality of replacement phrases, wherein the augmented prompt is generated based on the user input.

4. The method of claim 1, further comprising:
identifying an additional entity phrase in the text prompt; and
generating an additional replacement phrase for the additional entity phrase, wherein the augmented prompt includes the additional replacement phrase.

5. The method of claim 4, wherein:
the additional replacement phrase is generated based on the replacement phrase.

6. The method of claim 1, further comprising:
displaying the entity phrase;
receiving a selection of the entity phrase; and
displaying the replacement phrase in response to the selection.

7. The method of claim 1, further comprising:
generating, using an image generation model, a synthetic image based on the augmented prompt, wherein the synthetic image depicts an entity described by the replacement phrase.

8. The method of claim 1, further comprising:
retrieving a media item from a database based on the augmented prompt.

9. The method of claim 1, further comprising:
receiving a refresh command; and
generating an additional replacement phrase based on the refresh command.

10. The method of claim 1, wherein marking the entity phrase comprises:
inserting a first tag before the entity phrase and a second tag after the entity phrase.

11. The method of claim 1, wherein:
the language generation model is trained to generate the replacement phrase using a training set including a training text prompt and a training replacement phrase.

12. A method of training a machine learning model, the method comprising:
obtaining a training set including a training text prompt and a training replacement phrase, wherein the training text prompt includes a training entity phrase surrounded by a first tag and a second tag, and the training replacement phrase comprises a ground-truth variant of the training entity phrase; and
training, using the training set, a language generation model to generate a replacement phrase based on a text prompt, wherein the replacement phrase comprises a variant of an entity phrase in the text prompt.

13. The method of claim 12, wherein obtaining the training set comprises:
identifying the training entity phrase in the training text prompt; and
inserting the first tag before the training entity phrase and the second tag after the training entity phrase.

14. The method of claim 12, wherein training the language generation model comprises:
generating, using the language generation model, a training output based on the training text prompt;
computing a loss function based on the training output and the training replacement phrase; and
updating parameters of the language generation model based on the loss function.

15. The method of claim 12, wherein obtaining the training set comprises:
obtaining an additional replacement phrase comprising an additional variant of the training entity phrase.

16. A system for media processing, comprising:
at least one memory;
at least one processor executing instructions stored in the at least one memory;
an entity marking model comprising entity marking parameters stored in the at least one memory, the entity marking model trained to mark the entity phrase within a text prompt to obtain a revised prompt; and
a language generation model comprising text generation parameters stored in the at least one memory, the language generation model trained to generate a replacement phrase based on the revised prompt, wherein the replacement phrase comprises a variant of the entity phrase.

17. The system of claim 16, the system further comprising:
an augmentation component configured to generate an augmented prompt that includes the replacement phrase.

18. The system of claim 16, the system further comprising:
an image generation model comprising image generation parameters stored in the at least one memory, the image generation model configured to generate an image based on the replacement phrase.

19. The system of claim 16, the system further comprising:
a retrieval component configured to retrieve a media item from a database based on the replacement phrase.

20. The system of claim 16, the system further comprising:
a user interface configured to receive a selection of the entity phrase and display the replacement phrase in response to the selection.
